(19) United States
(12) Patent Application Publication
(10) Pub. No.: US 2013/0164510 A1
(43) Pub. Date: Jun. 27, 2013

(54) HIGH THERMALLY CONDUCTIVE COMPOSITES

(71) Applicants: Chien-Ming CHEN, TAOYUAN COUNTY (TW); Yao-Chu CHUNG, KAOHSIUNG CITY (TW); Fu-Ming CHIEN, HSINCHU CITY (TW); Chun-Hsiung LIAO, TAIPEI COUNTY (TW); Chih-Jen CHANG, MIAOLI COUNTY (TW); Chin-Lang WU, MIAOLI COUNTY (TW); Tien-Jung HUANG, HSINCHU COUNTY (TW); Cheng-Chou WONG, HSINCHU COUNTY (TW); Chih-Chung CHANG, CHANGHUA COUNTY (TW)

(72) Inventors: Chien-Ming CHEN, TAOYUAN COUNTY (TW); Yao-Chu CHUNG, KAOHSIUNG CITY (TW); Fu-Ming CHIEN, HSINCHU CITY (TW); Chun-Hsiung LIAO, TAIPEI COUNTY (TW); Chih-Jen CHANG, MIAOLI COUNTY (TW); Chin-Lang WU, MIAOLI COUNTY (TW); Tien-Jung HUANG, HSINCHU COUNTY (TW); Cheng-Chou WONG, HSINCHU COUNTY (TW); Chih-Chung CHANG, CHANGHUA COUNTY (TW)

(73) Assignee: INDUSTRIAL TECHNOLOGY RESEARCH INSTITUTE, HSINCHU (TW)

(21) Appl. No.: 13/467,976

(22) Filed: May 9, 2012

(30) Foreign Application Priority Data
Dec. 21, 2011 (TW) TW100147696

(51) Int. Cl. B32B 7/02; C09K 5/00; B82Y 30/00

(52) U.S. Cl. 428/212; 252/76; 977/701; 977/734; 977/742

(57) ABSTRACT

Disclosed is a high thermally conductive composite, including a first composite and a second composite having a co-continuous and incompatible dual-phase manner. The first composite consists of glass fiber distributed into polyphenylene sulfide, and the second composite consists of carbon material distributed into polyethylene terephthalate. The carbon material includes graphite, graphene, carbon fiber, carbon nanotube, or combinations thereof.

### CROSS REFERENCE TO RELATED APPLICATIONS

This application is based upon and claims the benefit of priority from the prior Taiwan Patent Application No. 100147696, filed on Dec. 21, 2011, the entire contents of which are incorporated herein by reference.

### TECHNICAL FIELD

The disclosure relates to thermally conductive composites, and in particular relates to the thermally conductive composites having a co-continuous and incompatible dual-phase manner.

### BACKGROUND

In recent years, electronic devices tend to be thinner, lighter, smaller, and shorter, but the functions thereof tend to be stronger. This means that the electronic devices need better thermal dissipation, and demand for thermal dissipation materials has grown. For example, thermal management industry sales reached 18 trillion New Taiwan Dollars in 2008. Most conventional thermal dissipation products have casting aluminum or filled thermoset epoxy resin with difficult processibility, high cost, and narrow applications. Thermally conductive plastics not only have thermal conductivity similar to that of metal and ceramic, but also have other plastic advantages such as designability, performance, and cost. For example, thermally conductive plastics have an average thermal dissipation, light-weight (40% to 50% lighter than aluminum), multi selections of basis resin, non-expensive and convenient moldings and processes, and high designable freedom.

Most of conventional thermally conductive products introduce a large amount of thermally conductive powder such as ceramic powder of BN, SiC, or AlN) and electrically conductive fiber such as carbon fiber and carbon nanotube into the thermoplastic polymer. The large amount of the thermally conductive powder is necessary for an excellent thermally conductive effect; however, it may dramatically reduce the end-point processibility and the physical properties of the composite. In addition, thermally conductive powder is a major cost of thermally conductive composite. The large amount of thermally conductive powder will make the composite lose its competitiveness.

Accordingly, a novel thermally conductive composite having a lower amount of conductive powder without sacrificing the conductivity thereof is called for

### SUMMARY

One embodiment of the disclosure provides a high thermally conductive composite, comprising: a first composite consisting of glass fiber distributed into polyphenylene sulfide; and a second composite consisting of carbon material distributed into polyethylene terephthalate, wherein the first composite and the second composite have a co-continuous and incompatible dual-phase manner.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a manner of a high thermally conductive composite in one embodiment of the disclosure.

### DETAILED DESCRIPTION

The following description is of the best-contemplated mode of carrying out the disclosure. This description is made for the purpose of illustrating the general principles of the invention and should not be taken in a limiting sense. The scope of the invention is best determined by reference to the appended claims.

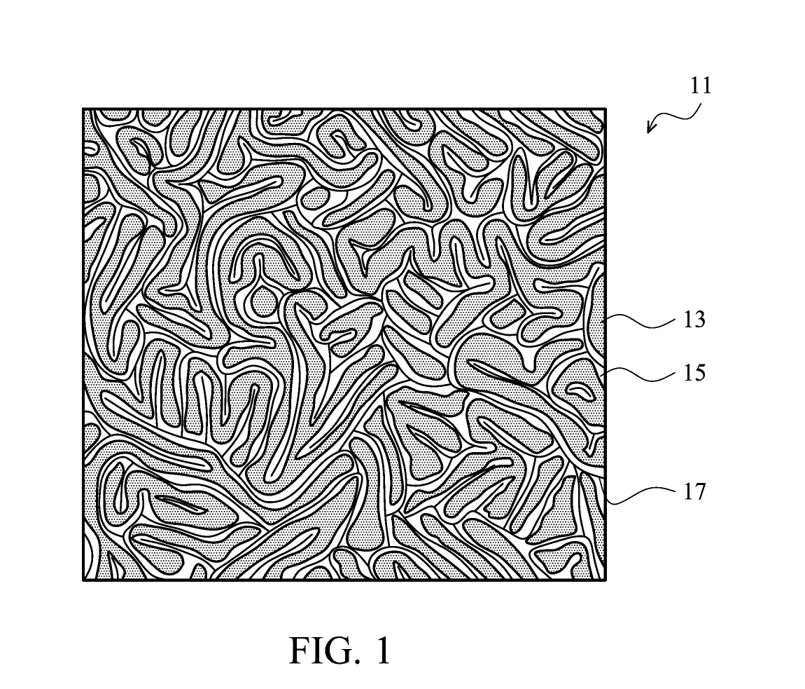

As shown in FIG. 1, a high thermally conductive composite 11 in one embodiment of the disclosure is composed of a first composite 13 and a second composite 15. The first composite 13 and the second composite 15 have a co-continuous and incompatible dual-phase manner. The first composite 13 consists of a glass fiber distributed into a polyphenylene sulfide (PPS). The glass fiber may enhance a mechanical strength of the high thermally conductive composite 11, and the PPS is a thermal resistant polymer. In one embodiment, the glass fiber and the PPS have a weight ratio of 10:90 to 40:60. An overly high amount of the glass fiber will make the first composite 13 lose its fluidity or even lose its processibility. An overly low amount of the glass fiber will not efficiently enhance the mechanical strength of the high thermally conductive composite 11. In one embodiment, the PSS has a melt flow index of 70 to 5000. A PSS having an overly high melt flow index will make the first composite 13 lose its fluidity or even lose its processibility.

The second composite 15 consists of a carbon material 17 distributed into a polyethylene terephthalate (PET). As shown in FIG. 1, the carbon material 17 is only distributed into the PET of the second composite 15, and connects to each other for providing thermally conductive paths. Because the carbon material 17 is not distributed into the first composite 13, the amount of the carbon material 17 can be reduced. The PET is a thermoplastic polymer, which benefits the compounding and molding processes. In one embodiment, the PET and the carbon material 17 have a weight ratio of 10:90 to 70:30. An overly high amount of the carbon material 17 will make the second composite 15 lose its fluidity or even lose its processibility, and make the high thermally conductive composite 11 lose its mechanical strength. An overly low amount of the carbon material 17 cannot make the high thermally conductive composite 11 have sufficient thermal conductivity. In one embodiment, the carbon material 17 can be graphite, graphene, carbon fiber, carbon nanotube, or combinations thereof. The carbon material 17 has a size of 150 μm to 600 μm. In one embodiment, the PET has an intrinsic viscosity of 0.4 to 2. In one embodiment, the first composite 13 and the second composite 15 have a weight ratio of 1:9 to 3:7. An overly low amount of the first composite 13 will cause the high thermally conductive material 11 to have an insufficient mechanical strength. An overly high amount of the first composite 13 will cause the high thermally conductive material 11 to have an insufficient thermal conductivity. An appropriate ratio of the first composite 13 and the second composite 15 are compounded to form the product. The product is sliced, and the slice face is then analyzed by a microscopy to show that the first composite 13 and the second composite 15 are a co-continuous phase. The glass fiber is only distributed into the first composite 13 and not distributed into the second composite 15, and the carbon material 17 is only distributed into the second composite 15 and not distributed into the first composite 13. Generally, the thermally conductive composite should have a thermal conductivity greater than 2 W/m·K and a heat deformation temperature (thermal resistance) greater than 100° C.

### EXAMPLES

The raw material sources, equipments, and analysis instruments are described as below:

PSS was P-4 commercially available from Chevron Phillips Chemical Company.

Glass fiber was R-4 commercially available from Chevron Phillips Chemical Company.

PC (polycarbonate) was 399 X 95997 B commercially available from RTP Company.

PA (polyarylate) was PTF-212-11 commercially available from Sabic Konduit.

PET was 5015W commercially available from Shinkong Synthetic Fibers Corporation, Taiwan.

Graphite powder was natural graphite commercially available from Taiwan Maxwave Co., Ltd.

Carbon fiber was DKD commercially available from Cytec. Industrial.

Compounding equipment was a twin screw extruder commercially available from Coperion Werner & Pfleiderer.

The thermal conductivity of the products was measured according to the ISO/DIS 22007-2 standard by the Transient Plane Source commercially available from Hot Disk AB.

### Comparative Example 1

80 parts by weight of the PPS and 20 parts by weight of the glass fiber were put in the compounding equipment to form a composite of a single polymer. The composite had a heat deformation temperature (HDT) of 220.1° C. and a thermal conductivity of 0.29 W/m·K.

### Comparative example 2

60 parts by weight of the PPS and 40 parts by weight of the graphite powder were charged in the compounding equipment to form a composite of a single polymer. The composite had a heat deformation temperature (HDT) of 195.5° C. and a thermal conductivity of 0.90 W/m·K.

### Comparative example 3

70 parts by weight of the composite in Comparative example 1 (PPS/glass fiber=80/20) and 30 parts by weight of the graphite powder were charged in the compounding equipment for mixing. The mixture could not form a composite to be stretched, and the properties of the mixture were too poor for processing.

### Comparative example 4

65 parts by weight of the PET and 35 parts by weight of the graphite powder were charged in the compounding equipment to form a composite of a single polymer. The composite had a heat deformation temperature (HDT) of 113.9° C. and a thermal conductivity of 2.33 W/m·K.

### Comparative example 5

b 60 parts by weight of the PET and 40 parts by weight of the graphite powder were charged in the compounding equipment to form a composite of a single polymer. The composite had a heat deformation temperature (HDT) of 105.0° C. and a thermal conductivity of 0.80 W/m·K.

### Comparative example 6

Less than 60 parts by weight of the PC and greater than 40 parts by weight of the carbon fiber were charged in the compounding equipment to form a composite of a single polymer. The composite had a heat deformation temperature (HDT) of 143° C. and a thermal conductivity of 2.20 W/m·K.

### Comparative example 7

Less than 60 parts by weight of the PA and greater than 40 parts by weight of the graphite powder were charged in the compounding equipment to form a composite of a single polymer. The composite had a heat deformation temperature (HDT) of 180° C. and a thermal conductivity of 0.9 W/m·K.

### Comparative example 8

70 parts by weight of the PET and 30 parts by weight of the graphite powder were charged in the compounding equipment to form a composite of a single polymer. The composite had a heat deformation temperature (HDT) of 106° C. and a thermal conductivity of 1.86 W/m·K.

### Example 1

10 parts by weight of the composite (PSS/glass fiber=80/20 in weight), 45 parts by weight of the PET, and 45 parts by weight of the graphite powder were charged in the compounding equipment to form a composite of a dual-phase polymer. The composite had a heat deformation temperature (HDT) of 191.6° C. and a thermal conductivity of 2.56 W/m·K.

### Example 2

20 parts by weight of the composite (PSS/glass fiber=80/20 in weight), 40 parts by weight of the PET, and 40 parts by weight of the graphite powder were charged in the compounding equipment to form a composite of a dual-phase polymer. The composite had a heat deformation temperature (HDT) of 196.8° C. and a thermal conductivity of 2.43 W/m·K.

### Example 3

30 parts by weight of the composite (PSS/glass fiber=80/20 in weight), 35 parts by weight of the PET, and 35 parts by weight of the graphite powder were charged in the compounding equipment to form a composite of a dual-phase polymer. The composite had a heat deformation temperature (HDT) of 206.6° C. and a thermal conductivity of 2.47 W/m·K.

The raw material ratios and properties of the products in Comparative Examples 1-4 and Examples 1-3 were tabulated and are shown in Table 1.

TABLE 1

| | Comparative | Comparative | Comparative | Comparative | Example | Example | Example |
|---|---|---|---|---|---|---|---|
| | example 1 | example 2 | example 3 | example 4 | 1 | 2 | 3 |
| PPS/glass fiber = 80/20 | 100 | none | 70 | none | 10 | 20 | 30 |
| PPS | none | 60 | none | none | none | none | none |
| PET | none | none | none | 65 | 45 | 40 | 35 |
| Graphite | none | 40 | 30 | 35 | 45 | 40 | 35 |
| Graphite content (wt %) | none | 40 | 30 | 35 | 45 | 40 | 35 |
| Manner | Single | Single | Single | Single | Dual- | Dual- | Dual- |
| | polymer | polymer | polymer | polymer | phase | phase | phase |
| | | | | | polymer | polymer | polymer |
| HDT(° C.) | 220.1 | 195.5 | — | 113.9 | 191.6 | 196.8 | 206.6 |
| Thermal conductivity | 0.29 | 0.90 | — | 2.33 | 2.56 | 2.43 | 2.47 |
| (W/m · K) | | | | | | | |
| Note | | | Could not be | | | | |
| | | | processed | | | | |

### Example 4

30 parts by weight of the composite (PSS/glass fiber=80/20 in weight), 35 parts by weight of the PET, and 35 parts by weight of the carbon fiber were charged in the compounding equipment to form a composite of a dual-phase polymer. The composite had a heat deformation temperature (HDT) of 161.4° C. and a thermal conductivity of 1.34 W/m·K.

The raw material ratios and properties of the products in Comparative Examples 4-7 and Examples 3-4 were tabulated and are shown in Table 2.

TABLE 2

| | Comparative | Comparative | Comparative | Comparative | Example | Example |
|---|---|---|---|---|---|---|
| | example 4 | example 5 | example 6 | example 7 | 3 | 4 |
| PPS/glass fiber = 80/20 | none | none | none | none | 30 | 30 |
| PET | 65 | 60 | none | none | 35 | 35 |
| Graphite | 35 | none | >40% | >40% | 35 | none |
| Carbon fiber | None | 40 | none | none | none | 35 |
| Carbon material content (wt %) | 35 | 40 | >40% | >40% | 35 | 35 |
| Manner | Single | Single | Single | Single | Dual- | Dual- |
| | polymer | polymer | polymer | polymer | phase | phase |
| | | | | | polymer | polymer |
| HDT(° C.) | 113.9 | 105.0 | 143 | 180 | 206.6 | 161.4 |
| Thermal conductivity | 2.33 | 0.80 | 2.20 | 0.9 | 2.47 | 1.34 |
| (W/m · K) | | | | | | |

### Example 5

The PSS, the glass fiber, the PET, and the graphite powder were weighted according to ratios of 10 parts by weight of a first composite (PSS/glass fiber=90/10 in weight) and 90 parts by weight of a second composite (PET/graphite powder=70/30 in weight), and then charged in the compounding equipment to form a composite of a dual-phase polymer. The composite had a heat deformation temperature (HDT) of 164.6° C. and a thermal conductivity of 1.93 W/m·K.

### Example 6

The PSS, the glass fiber, the PET, and the graphite powder were weighted according to ratios of 30 parts by weight of a first composite (PSS/glass fiber=90/10 in weight) and 70 parts by weight of a second composite (PET/graphite powder=70/30 in weight), and then charged in the compounding equipment to form a composite of a dual-phase polymer. The composite had a heat deformation temperature (HDT) of 166.3° C. and a thermal conductivity of 1.11 W/m·K.

### Example 7

The PSS, the glass fiber, the PET, and the graphite powder were weighted according to ratios of 50 parts by weight of a first composite (PSS/glass fiber=90/10 in weight) and 50 parts by weight of a second composite (PET/graphite powder=70/30 in weight), and then charged in the compounding equipment to form a composite of a dual-phase polymer. The composite had a heat deformation temperature (HDT) of 166.9° C. and a thermal conductivity of 0.81 W/m·K.

### Example 8

The PSS, the glass fiber, the PET, and the graphite powder were weighted according to ratios of 10 parts by weight of a first composite (PSS/glass fiber=90/10 in weight) and 90 parts by weight of a second composite (PET/graphite powder=50/50 in weight), and then charged in the compounding equipment to form a composite of a dual-phase polymer. The composite had a heat deformation temperature (HDT) of 192.9° C. and a thermal conductivity of 2.52 W/m·K.

### Example 9

The PSS, the glass fiber, the PET, and the graphite powder were weighted according to ratios of 30 parts by weight of a first composite (PSS/glass fiber=90/10 in weight) and 70 parts by weight of a second composite (PET/graphite powder=50/50 in weight), and then charged in the compounding equipment to form a composite of a dual-phase polymer. The composite had a heat deformation temperature (HDT) of 193.7° C. and a thermal conductivity of 2.47 W/m·K.

### Example 10

The PSS, the glass fiber, the PET, and the graphite powder were weighted according to ratios of 50 parts by weight of a first composite (PSS/glass fiber=90/10 in weight) and 50 parts by weight of a second composite (PET/graphite powder=50/50 in weight), and then charged in the compounding equipment to form a composite of a dual-phase polymer. The composite had a heat deformation temperature (HDT) of 207.4° C. and a thermal conductivity of 1.28 W/m·K.

The raw material ratios and properties of the products in Comparative Example 8 and Examples 5-10 were tabulated and are shown in Table 3.

TABLE 3

| | Comparative | Example | Example | Example | Example | Example | Example |
|---|---|---|---|---|---|---|---|
| | example 8 | 5 | 6 | 7 | 8 | 9 | 10 |
| PPS/glass fiber = 90/10 | none | 10 | 30 | 50 | 10 | 30 | 50 |
| PET/graphite = 70/30 | 100 | 90 | 70 | 50 | none | none | none |
| PET/graphite = 50/50 | none | none | none | none | 90 | 70 | 50 |
| Graphite content (wt %) | 30 | 27 | 21 | 15 | 45 | 35 | 25 |
| Manner | Single | Dual- | Dual- | Dual- | Dual- | Dual- | Dual- |
| | polymer | phase | phase | phase | phase | phase | phase |
| | | polymer | polymer | polymer | polymer | polymer | polymer |
| HDT(° C.) | 106 | 164.6 | 166.3 | 166.9 | 192.9 | 193.7 | 207.4 |
| Thermal conductivity | 1.86 | 1.93 | 1.11 | 0.81 | 2.52 | 2.47 | 1.28 |
| (W/m · K) | | | | | | | |

### Example 11

The PSS, the glass fiber, the PET, and the graphite powder were weighted according to ratios of 10 parts by weight of a first composite (PSS/glass fiber=80/20 in weight) and 90 parts by weight of a second composite (PET/graphite powder=70/30 in weight), and then charged in the compounding equipment to form a composite of a dual-phase polymer. The composite had a heat deformation temperature (HDT) of 174.2° C. and a thermal conductivity of 1.98 W/m·K.

### Example 12

The PSS, the glass fiber, the PET, and the graphite powder were weighted according to ratios of 30 parts by weight of a first composite (PSS/glass fiber=80/20 in weight) and 70 parts by weight of a second composite (PET/graphite powder=70/30 in weight), and then charged in the compounding equipment to form a composite of a dual-phase polymer. The composite had a heat deformation temperature (HDT) of 190.7° C. and a thermal conductivity of 1.09 W/m·K.

### Example 13

The PSS, the glass fiber, the PET, and the graphite powder were weighted according to ratios of 50 parts by weight of a first composite (PSS/glass fiber=80/20 in weight) and 50 parts by weight of a second composite (PET/graphite powder=70/30 in weight), and then charged in the compounding equipment to form a composite of a dual-phase polymer. The composite had a heat deformation temperature (HDT) of 191° C. and a thermal conductivity of 0.98 W/m·K.

### Example 14

The PSS, the glass fiber, the PET, and the graphite powder were weighted according to ratios of 10 parts by weight of a first composite (PSS/glass fiber=80/20 in weight) and 90 parts by weight of a second composite (PET/graphite powder=50/50 in weight), and then charged in the compounding equipment to form a composite of a dual-phase polymer. The composite had a heat deformation temperature (HDT) of 191.6° C. and a thermal conductivity of 2.56 W/m·K.

### Example 15

The PSS, the glass fiber, the PET, and the graphite powder were weighted according to ratios of 30 parts by weight of a first composite (PSS/glass fiber=80/20 in weight) and 70 parts by weight of a second composite (PET/graphite powder=50/50 in weight), and then charged in the compounding equipment to form a composite of a dual-phase polymer. The composite had a heat deformation temperature (HDT) of 206.6° C. and a thermal conductivity of 2.43 W/m·K.

### Example 16

The PSS, the glass fiber, the PET, and the graphite powder were weighted according to ratios of 50 parts by weight of a first composite (PSS/glass fiber=80/20 in weight) and 50 parts by weight of a second composite (PET/graphite powder=50/50 in weight), and then charged in the compounding equipment to form a composite of a dual-phase polymer. The composite had a heat deformation temperature (HDT) of 215.7° C. and a thermal conductivity of 1.38 W/m·K.

The raw material ratios and properties of the products in Comparative Example 8 and Examples 11-16 were tabulated and are shown in Table 4.

TABLE 4

| | Comparative | Example | Example | Example | Example | Example | Example |
|---|---|---|---|---|---|---|---|
| | example 8 | 11 | 12 | 13 | 14 | 15 | 16 |
| PPS/glass fiber = 80/20 | none | 10 | 30 | 50 | 10 | 30 | 50 |
| PET/graphite = 70/30 | 100 | 90 | 70 | 50 | none | none | none |
| PET/graphite = 50/50 | none | none | none | none | 90 | 70 | 50 |
| Graphite content (wt %) | 30 | 27 | 21 | 15 | 45 | 35 | 25 |
| Manner | Single | Dual- | Dual- | Dual- | Dual- | Dual- | Dual- |
| | polymer | phase | phase | phase | phase | phase | phase |
| | | polymer | polymer | polymer | polymer | polymer | polymer |
| HDT | 106 | 174.2 | 190.7 | 191 | 191.6 | 206.6 | 215.7 |
| Thermal conductivity | 1.86 | 1.98 | 1.09 | 0.98 | 2.56 | 2.43 | 1.38 |
| (W/m · K) | | | | | | | |

As shown in Examples and Comparative examples, the composites of the dual-phase polymer had higher thermal conductivity and thermal resistance than that of the composites of the single polymer.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A high thermally conductive composite, comprising:
a first composite consisting of glass fiber distributed into polyphenylene sulfide; and
a second composite consisting of carbon material distributed into polyethylene terephthalate,
wherein the first composite and the second composite have a co-continuous and incompatible dual-phase manner.

2. The high thermally conductive composite as claimed in claim 1, wherein the first composite and the second composite have a weight ratio of 1:9 to 3:7.

3. The high thermally conductive composite as claimed in claim 1, wherein the glass fiber and the polyphenylene sulfide of the first composite have a weight ratio of 10:90 to 40:60.

4. The high thermally conductive composite as claimed in claim 1, wherein the polyphenylene sulfide has a melt flow index of 70 to 5000.

5. The high thermally conductive composite as claimed in claim 1, wherein the polyethylene terephthalate and the carbon material of the second composite have a weight ratio of 10:90 to 70:30.

6. The high thermally conductive composite as claimed in claim 1, wherein the polyethylene terephthalate has an intrinsic viscosity of 0.4 to 2.

7. The high thermally conductive composite as claimed in claim 1, wherein the carbon material comprises graphite, graphene, carbon fiber, carbon nanotube, or combinations thereof.
